(19) United States
(12) Patent Application Publication
(10) Pub. No.: US 2006/0113696 A1
(43) Pub. Date: Jun. 1, 2006

(54) Low cost vehicle fuel system components manufactured from conductive loaded resin-based materials

(75) Inventor: Thomas Aisenbrey, Littleton, CO (US)

Correspondence Address: STEPHEN B. ACKERMAN, 28 DAVIS AVENUE, POUGHKEEPSIE, NY, 12603, US

(73) Assignee: Integral Technologies, Inc.

(21) Appl. No.: 11/179,253

(22) Filed: Jul. 12, 2005

Related U.S. Application Data
(60) Provisional application No. 60/587,289, filed on Jul. 12, 2004.

(51) Int. Cl. C04B 35/00; B29D 23/00

(52) U.S. Cl. 264/104; 264/209.1; 264/328.1

(57) ABSTRACT

Vehicle fuel system components are formed of a conductive loaded resin-based material. The conductive loaded resin-based material comprises micron conductive powder(s), conductive fiber(s), or a combination of conductive powder and conductive fibers in a base resin host. The percentage by weight of the conductive powder(s), conductive fiber(s), or a combination thereof is between about 20% and 50% of the weight of the conductive loaded resin-based material. The micron conductive powders are metals or conductive non-metals or metal plated non-metals. The micron conductive fibers may be metal fiber or metal plated fiber. Further, the metal plated fiber may be formed by plating metal onto a metal fiber or by plating metal onto a non-metal fiber. Any platable fiber may be used as the core for a non-metal fiber. Superconductor metals may also be used as micron conductive fibers and/or as metal plating onto fibers in the present invention.

### RELATED PATENT APPLICATIONS

This Patent Application is related to U.S. patent application INT04-025A, Ser. No. ______, and filed on ______ which is herein incorporated by reference in its entirety.

This Patent Application claims priority to the U.S. Provisional Patent Application 60/587,289 filed on Jul. 12, 2004, which is herein incorporated by reference in its entirety.

This Patent Application is a Continuation-in-Part of INT01-002CIPC, filed as U.S. patent application Ser. No. 10/877,092, filed on Jun. 25, 2004, which is a Continuation of INT01-002CIP, filed as U.S. patent application Ser. No. 10/309,429, filed on Dec. 4, 2002, now issued as U.S. Pat. No. 6,870,516, also incorporated by reference in its entirety, which is a Continuation-in-Part application of docket number INT01-002, filed as U.S. patent application Ser. No. 10/075,778, filed on Feb. 14, 2002, now issued as U.S. Pat. No. 6,741,221, which claimed priority to US Provisional Patent Applications Ser. No. 60/317,808, filed on Sep. 7, 2001, Ser. No. 60/269,414, filed on Feb. 16, 2001, and Ser. No. 60/268,822, filed on Feb. 15, 2001, all of which are incorporated by reference in their entirety.

### BACKGROUND OF THE INVENTION

(1) Field of the Invention

This invention relates to vehicle fuel system components and, more particularly, to vehicle fuel system components molded of conductive loaded resin-based materials comprising micron conductive powders, micron conductive fibers, or a combination thereof, substantially homogenized within a base resin when molded. This manufacturing process yields a conductive part or material usable within the EMF, thermal, acoustic, or electronic spectrum(s).

(2) Description of the Prior Art

Internal combustion engines require a fuel system to deliver fuel to the engine during operation. Vehicle fuel systems comprise a number of components to store, transport, and meter fuel. Fuel tanks, hoses, piping, manifolds, rails, filters, pumps, carburetors, and injectors are just some of the components found in a modern vehicle fuel system. It is important that the component material be one that is non-reactive with the fuel. In addition, the material should not support the build-up of electrostatic charge. Therefore, these components are typically manufactured from metal materials such as aluminum or steel. However, metal-based components can be very heavy and can be expensive to manufacture. A primary objective of the present invention is to construct various vehicle fuel system components from a unique material that provides excellent electrical conductivity, non-reactive properties, and low weight combined with the ease of manufacture of a moldable part.

Several prior art inventions relate to vehicle fuel system components. U.S. Patent Publication US 2003/0131828 A1 to Crary teaches an in-tank fuel module inlet strainer with ESD protection where most of the module components such as the reservoir, motor/pump sleeve, regulator receptacle and filter housing are rendered conductive through the use of metal fibers or carbon powder in the polymeric matrix. U.S. Pat. No. 5,567,296 to Luch teaches a composite fuel tank comprising layers of polymer and metal joined together in a secure laminated structure. This also teaches an electroplateable resin having a polymer matrix consisting of carbon black and sulfur. U.S. Pat. No. 6,436,287 B1 to Fischerkeller et al teaches a fuel pump module that utilizes fuel resistant conductive plastics in all or part of the components in order to help reduce and/or eliminate electrostatic charges that tend to build up in the fuel tank environment.

U.S. Patent Publication US 2004/0018328 A1 to Yamada et al teaches a layered resinous electrically conductive polyester tube for piping a fuel system of an automotive vehicle. Providing electrical conductivity to the innermost layer is accomplished by adding an electrically conductive carbonaceous material such as carbon black to the polymer matrix. U.S. Patent Publication US 2003/0098085 A1 to Ito et al teaches an automotive fuel hose that satisfies low permeability requirements against the vapor emission of hydrocarbons and excellent in sour gasoline resistance and inter-layer adhesion. This also teaches the use of an electrically conductive material such as carbon black, nano-carbon, metal powder or metal oxide powder blended in the inner layer material of a fluororesin or a polyolefin resin. This also teaches a plasma-treated inner layer on both sides for restricted vapor emissions. U.S. Patent Publication US 2003/0099799 A1 to Koike et al teaches a layered resin hose for fuel comprising carbon black, graphite, stainless steel, or other metal materials of high conductivity such as Au, Ag, Cu, Ni, Pd, and Si, and metal oxides in the resin base. The invention also teaches co-extrusion of layers. U.S. Patent Publication US 2003/0098307 A1 to Hagano et al teaches a cap device for an automobile fuel tank that contains a cover comprising polyamide (PA), polyethylene (PP), acrylonitrile-butadiene-styrene (ABS) or polycarbonate (PC) and a metal filler such as stainless steel, nickel, chromium, zinc, copper, aluminum, gold, silver, magnesium or titanium filler or some combination thereof. The metal filler content is from 1 to 30% by weight and is used to render the cover conductive.

### SUMMARY OF THE INVENTION

A principal object of the present invention is to provide an effective vehicle fuel system component.

A further object of the present invention is to provide a method to form a vehicle fuel system component.

A further object of the present invention is to provide a vehicle fuel system component molded of conductive loaded resin-based materials.

A further object of the present invention is to provide a vehicle fuel system component having reduced weight.

A further object of the present invention is to provide a vehicle fuel system component having excellent conductivity and electrostatic charge dissipation capability.

A further object of the present invention is to provide a vehicle fuel system component that is fuel impermeable.

A yet further object of the present invention is to provide a vehicle fuel system component molded of conductive loaded resin-based material where the electrical or thermal characteristics can be altered or the visual characteristics can be altered by forming a metal layer over the conductive loaded resin-based material.

A yet further object of the present invention is to provide methods to fabricate a vehicle fuel system component from a conductive loaded resin-based material incorporating various forms of the material.

A yet further object of the present invention is to provide a method to fabricate a vehicle fuel system component from a conductive loaded resin-based material where the material is in the form of a fabric.

In accordance with the objects of this invention, a vehicle fuel delivery device comprising a hollow fuel holding or transporting structure comprising a conductive loaded, resin-based material comprising conductive materials in a base resin host

Also in accordance with the objects of this invention, a vehicle fuel delivery device is achieved. The device comprises a hollow fuel holding or transporting structure comprising a conductive loaded, resin-based material comprising conductive materials in a base resin host. The percent by weight of the conductive materials is between about 20% and about 50% of the total weight of the conductive loaded resin-based material.

Also in accordance with the objects of this invention, a vehicle fuel delivery device is achieved. The device comprises a hollow fuel holding or transporting structure comprising a conductive loaded, resin-based material comprising micron conductive fiber in a base resin host. The percent by weight of the micron conductive fiber is between about 20% and about 50% of the total weight of the conductive loaded resin-based material.

Also in accordance with the objects of this invention, a method to form a vehicle fuel delivery device is achieved. The method comprises providing a conductive loaded, resin-based material comprising conductive materials in a resin-based host. The conductive loaded, resin-based material is molded into a vehicle fuel delivery device comprising a hollow fuel holding or transporting structure.

Also in accordance with the objects of this invention, a method to form a vehicle fuel delivery device is achieved. The method comprises providing a conductive loaded, resin-based material comprising conductive materials in a resin-based host. The percent by weight of the conductive materials is between 20% and 40% of the total weight of the conductive loaded resin-based material. The conductive loaded, resin-based material is molded into a vehicle fuel delivery device comprising a hollow fuel holding or transporting structure.

Also in accordance with the objects of this invention, a method to form a vehicle fuel delivery device is achieved. The method comprises providing a conductive loaded, resin-based material comprising micron conductive fiber in a resin-based host. The percent by weight of the micron conductive fiber is between 20% and 50% of the total weight of the conductive loaded resin-based material. The conductive loaded, resin-based material is molded into a vehicle fuel delivery device comprising a hollow fuel holding or transporting structure.

### BRIEF DESCRIPTION OF THE DRAWINGS

In the accompanying drawings forming a material part of this description, there is shown:

FIG. 1 illustrates a first preferred embodiment of the present invention showing a fuel hose formed of conductive loaded resin-based material.

FIG. 2 illustrates a first preferred embodiment of a conductive loaded resin-based material wherein the conductive materials comprise a powder.

FIG. 3 illustrates a second preferred embodiment of a conductive loaded resin-based material wherein the conductive materials comprise micron conductive fibers.

FIG. 4 illustrates a third preferred embodiment of a conductive loaded resin-based material wherein the conductive materials comprise both conductive powder and micron conductive fibers.

FIGS. 5a and 5b illustrate a fourth preferred embodiment wherein conductive fabric-like materials are formed from the conductive loaded resin-based material.

FIGS. 6a and 6b illustrate, in simplified schematic form, an injection molding apparatus and an extrusion molding apparatus that may be used to mold vehicle fuel system components of a conductive loaded resin-based material.

FIG. 7 illustrates a second preferred embodiment of the present invention showing a fuel cap formed of conductive loaded resin-based material.

FIG. 8 illustrates a third preferred embodiment of the present invention showing a fuel tank formed of conductive loaded resin-based material.

FIG. 9 illustrates a fourth preferred embodiment of the present invention showing a fuel tank filler neck formed of conductive loaded resin-based material.

FIG. 10 illustrates a fifth preferred embodiment of the present invention showing a fuel injector formed of conductive loaded resin-based material.

FIG. 11 illustrates a sixth preferred embodiment of the present invention showing a fuel rail formed of conductive loaded resin-based material.

FIG. 12 illustrates a seventh preferred embodiment of the present invention showing a carburetor formed of conductive loaded resin-based material.

FIG. 13 illustrates an eighth preferred embodiment of the present invention showing a fuel filter housing formed of conductive loaded resin-based material.

FIGS. 14a-14c illustrates a ninth preferred embodiment of the present invention showing a fuel pump formed of conductive loaded resin-based material.

### DESCRIPTION OF THE PREFERRED EMBODIMENTS

This invention relates to vehicle fuel system components molded of conductive loaded resin-based materials comprising micron conductive powders, micron conductive fibers, or a combination thereof, substantially homogenized within a base resin when molded.

The conductive loaded resin-based materials of the invention are base resins loaded with conductive materials, which then makes any base resin a conductor rather than an insulator. The resins provide the structural integrity to the molded part. The micron conductive fibers, micron conductive powders, or a combination thereof, are substantially homogenized within the resin during the molding process, providing the electrical, thermal, and/or acoustical continuity.

The conductive loaded resin-based materials can be molded, extruded or the like to provide almost any desired shape or size. The molded conductive loaded resin-based materials can also be cut, stamped, or vacuumed formed from an injection molded or extruded sheet or bar stock, over-molded, laminated, milled or the like to provide the desired shape and size. The thermal or electrical conductivity characteristics of vehicle fuel system components fabricated using conductive loaded resin-based materials depend on the composition of the conductive loaded resin-based materials, of which the loading or doping parameters can be adjusted, to aid in achieving the desired structural, electrical or other physical characteristics of the material. The selected materials used to fabricate the vehicle fuel system components are substantially homogenized together using molding techniques and or methods such as injection molding, over-molding, insert molding, thermo-set, protrusion, extrusion, calendaring, or the like. Characteristics related to 2D, 3D, 4D, and 5D designs, molding and electrical characteristics, include the physical and electrical advantages that can be achieved during the molding process of the actual parts and the polymer physics associated within the conductive networks within the molded part(s) or formed material(s).

In the conductive loaded resin-based material, electrons travel from point to point when under stress, following the path of least resistance. Most resin-based materials are insulators and represent a high resistance to electron passage. The doping of the conductive loading into the resin-based material alters the inherent resistance of the polymers. At a threshold concentration of conductive loading, the resistance through the combined mass is lowered enough to allow electron movement. Speed of electron movement depends on conductive loading concentration, that is, the separation between the conductive loading particles. Increasing conductive loading content reduces interparticle separation distance, and, at a critical distance known as the percolation point, resistance decreases dramatically and electrons move rapidly.

Resistivity is a material property that depends on the atomic bonding and on the microstructure of the material. The atomic microstructure material properties within the conductive loaded resin-based material are altered when molded into a structure. A substantially homogenized conductive microstructure of delocalized valance electrons is created. This microstructure provides sufficient charge carriers within the molded matrix structure. As a result, a low density, low resistivity, lightweight, durable, resin based polymer microstructure material is achieved. This material exhibits conductivity comparable to that of highly conductive metals such as silver, copper or aluminum, while maintaining the superior structural characteristics found in many plastics and rubbers or other structural resin based materials.

The use of conductive loaded resin-based materials in the fabrication of vehicle fuel system components significantly lowers the cost of materials and the design and manufacturing processes used to hold ease of close tolerances, by forming these materials into desired shapes and sizes. The components can be manufactured into infinite shapes and sizes using conventional forming methods such as injection molding, over-molding, or extrusion, calendaring, or the like. The conductive loaded resin-based materials, when molded, typically but not exclusively produce a desirable usable range of resistivity from between about 5 and 25 ohms per square, but other resistivities can be achieved by varying the doping parameters and/or resin selection(s).

The conductive loaded resin-based materials comprise micron conductive powders, micron conductive fibers, or any combination thereof, which are substantially homogenized together within the base resin, during the molding process, yielding an easy to produce low cost, electrically conductive, close tolerance manufactured part or circuit. The resulting molded article comprises a three dimensional, continuous network of conductive loading and polymer matrix. Exemplary micron conductive powders include carbons, graphites, amines or the like, and/or of metal powders such as nickel, copper, silver, aluminum, or plated or the like. The use of carbons or other forms of powders such as graphite(s) etc. can create additional low level electron exchange and, when used in combination with micron conductive fibers, creates a micron filler element within the micron conductive network of fiber(s) producing further electrical conductivity as well as acting as a lubricant for the molding equipment. Carbon nano-tubes may be added to the conductive loaded resin-based material. The addition of conductive powder to the micron conductive fiber loading may increase the surface conductivity of the molded part, particularly in areas where a skinning effect occurs during molding.

The micron conductive fibers may be metal fiber or metal plated fiber. Further, the metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, or the like, or combinations thereof. Exemplary metal plating materials include, but are not limited to, copper, nickel, cobalt, silver, gold, palladium, platinum, ruthenium, and rhodium, and alloys of thereof. Any platable fiber may be used as the core for a non-metal fiber. Exemplary non-metal fibers include, but are not limited to, carbon, graphite, polyester, basalt, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fibers in the present invention.

The structural material may be any polymer resin or combination of polymer resins. Non-conductive resins or inherently or intrinsically conductive resins may be used as the structural material. Conjugated polymer resins, complex polymer resins, and/or inherently or intrinsically conductive resins may be used as the structural material. The dielectric properties of the resin-based material will have a direct effect upon the final electrical performance of the conductive loaded resin-based material. Many different dielectric properties are possible depending on the chemical makeup and/or arrangement, such as linking, cross-linking or the like, of the polymer, co-polymer, or monomer material. Structural material can be, here given as examples and not as an exhaustive list, polymer resins produced by GE PLASTICS, Pittsfield, Mass., a range of other plastics produced by GE PLASTICS, Pittsfield, Mass., a range of other plastics produced by other manufacturers, silicones produced by GE SILICONES, Waterford, N.Y., or other flexible resin-based rubber compounds produced by other manufacturers.

The resin-based structural material loaded with micron conductive powders, micron conductive fibers, or in combination thereof can be molded, using conventional molding methods such as injection molding or over-molding, or extrusion, or compression molding, or calendaring, to create desired shapes and sizes. The molded conductive loaded resin-based materials can also be stamped, cut or milled as desired to form create the desired shape form factor(s) of the vehicle fuel system components. The doping composition and directionality associated with the micron conductors within the loaded base resins can affect the electrical and structural characteristics of the devices and can be precisely controlled by mold designs, gating and or protrusion design(s) and or during the molding process itself. In addition, the resin base can be selected to obtain the desired thermal characteristics such as very high melting point or specific thermal conductivity.

A resin-based sandwich laminate could also be fabricated with random or continuous webbed micron stainless steel fibers or other conductive fibers, forming a cloth like material. The webbed conductive fiber can be laminated or the like to materials such as Teflon, Polyesters, or any resin-based flexible or solid material(s), which when discretely designed in fiber content(s), orientation(s) and shape(s), will produce a very highly conductive flexible cloth-like material. Such a cloth-like material could also be used in forming vehicle fuel system components that could be embedded in other resin materials such as rubber(s) or plastic(s). When using conductive fibers as a webbed conductor as part of a laminate or cloth-like material, the fibers may have diameters of between about 3 and 12 microns, typically between about 8 and 12 microns or in the range of about 10 microns, with length(s) that can be seamless or overlapping.

The conductive loaded resin-based material may also be formed into a prepreg laminate. A laminate, cloth, or webbing of the conductive loaded resin-based material is first impregnated with a resin-based material. In various embodiments, the conductive loaded resin-based material is dipped, coated, sprayed, and/or extruded with resin-based material to cause the laminate, cloth, or webbing to adhere together in a prepreg grouping that is easy to handle. This prepreg is then placed, or laid up, onto a form and heated to form a permanent bond. In another embodiment, the prepreg laid up onto the impregnating resin while the resin is still wet and then cured by heating or other means. In yet another embodiment, a wet prepreg is formed by spraying, dipping, or coating the conductive loaded resin-based material laminate, cloth, or webbing in high temperature capable paint.

The conductive loaded resin-based material of the present invention can be made resistant to corrosion and/or metal electrolysis by selecting micron conductive fiber and/or micron conductive powder and base resin that are resistant to corrosion and/or metal electrolysis. For example, if a corrosion/electrolysis resistant base resin is combined with stainless steel fiber and carbon fiber/powder, then a corrosion and/or metal electrolysis resistant conductive loaded resin-based material is achieved. Another additional and important feature of the present invention is that the conductive loaded resin-based material of the present invention may be made flame retardant. Selection of a flame-retardant (FR) base resin material allows the resulting product to exhibit flame retardant capability. This is especially important in vehicle fuel system components applications as described herein.

The substantially homogeneous mixing of micron conductive fiber and/or micron conductive powder and base resin described in the present invention may also be described as doping. That is, the substantially homogeneous mixing converts the typically non-conductive base resin material into a conductive material. This process is analogous to the doping process whereby a semiconductor material, such as silicon, can be converted into a conductive material through the introduction of donor/acceptor ions as is well known in the art of semiconductor devices. Therefore, the present invention uses the term doping to mean converting a typically non-conductive base resin material into a conductive material through the substantially homogeneous mixing of micron conductive fiber and/or micron conductive powder into a base resin.

As an additional and important feature of the present invention, the molded conductor loaded resin-based material exhibits excellent thermal dissipation characteristics. Therefore, vehicle fuel system components manufactured from the molded conductor loaded resin-based material can provide added thermal dissipation capabilities to the application. For example, heat can be dissipated from electrical devices physically and/or electrically connected to vehicle fuel system components of the present invention.

As a significant advantage of the present invention, vehicle fuel system components constructed of the conductive loaded resin-based material can be easily interfaced to an electrical circuit or grounded. In one embodiment, a wire can be attached to a conductive loaded resin-based vehicle fuel system component via a screw that is fastened to the component. For example, a simple sheet-metal type, self tapping screw, when fastened to the material, can achieve excellent electrical connectivity via the conductive matrix of the conductive loaded resin-based material. To facilitate this approach a boss may be molded into the conductive loaded resin-based material to accommodate such a screw. Alternatively, if a solderable screw material, such as copper, is used, then a wire can be soldered to the screw that is embedded into the conductive loaded resin-based material. In another embodiment, the conductive loaded resin-based material is partly or completely plated with a metal layer. The metal layer forms excellent electrical conductivity with the conductive matrix. A connection of this metal layer to another circuit or to ground is then made. For example, if the metal layer is solderable, then a soldered connection may be made between the vehicle fuel system component and a grounding wire.

Where a metal layer is formed over the surface of the conductive loaded resin-based material, any of several techniques may be used to form this metal layer. This metal layer may be used for visual enhancement of the molded conductive loaded resin-based material article or to otherwise alter performance properties. Well-known techniques, such as electroless metal plating, electro metal plating, sputtering, metal vapor deposition, metallic painting, or the like, may be applied to the formation of this metal layer. If metal plating is used, then the resin-based structural material of the conductive loaded, resin-based material is one that can be metal plated. There are many of the polymer resins that can be plated with metal layers. For example, GE Plastics, SUPEC, VALOX, ULTEM, CYCOLAC, UGIKRAL, STYRON, CYCOLOY are a few resin-based materials that can be metal plated. Electroless plating is typically a multiple-stage chemical process where, for example, a thin copper layer is first deposited to form a conductive layer. This conductive layer is then used as an electrode for the subsequent plating of a thicker metal layer.

A typical metal deposition process for forming a metal layer onto the conductive loaded resin-based material is vacuum metallization. Vacuum metallization is the process where a metal layer, such as aluminum, is deposited on the conductive loaded resin-based material inside a vacuum chamber. In a metallic painting process, metal particles, such as silver, copper, or nickel, or the like, are dispersed in an acrylic, vinyl, epoxy, or urethane binder. Most resin-based materials accept and hold paint well, and automatic spraying systems apply coating with consistency. In addition, the excellent conductivity of the conductive loaded resin-based material of the present invention facilitates the use of extremely efficient, electrostatic painting techniques.

The conductive loaded resin-based material can be contacted in any of several ways. In one embodiment, a pin is embedded into the conductive loaded resin-based material by insert molding, ultrasonic welding, pressing, or other means. A connection with a metal wire can easily be made to this pin and results in excellent contact to the conductive loaded resin-based material. In another embodiment, a hole is formed in to the conductive loaded resin-based material either during the molding process or by a subsequent process step such as drilling, punching, or the like. A pin is then placed into the hole and is then ultrasonically welded to form a permanent mechanical and electrical contact. In yet another embodiment, a pin or a wire is soldered to the conductive loaded resin-based material. In this case, a hole is formed in the conductive loaded resin-based material either during the molding operation or by drilling, stamping, punching, or the like. A solderable layer is then formed in the hole. The solderable layer is preferably formed by metal plating. A conductor is placed into the hole and then mechanically and electrically bonded by point, wave, or reflow soldering.

Another method to provide connectivity to the conductive loaded resin-based material is through the application of a solderable ink film to the surface. One exemplary solderable ink is a combination of copper and solder particles in an epoxy resin binder. The resulting mixture is an active, screen-printable and dispensable material. During curing, the solder reflows to coat and to connect the copper particles and to thereby form a cured surface that is directly solderable without the need for additional plating or other processing steps. Any solderable material may then be mechanically and/or electrically attached, via soldering, to the conductive loaded resin-based material at the location of the applied solderable ink. Many other types of solderable inks can be used to provide this solderable surface onto the conductive loaded resin-based material of the present invention. Another exemplary embodiment of a solderable ink is a mixture of one or more metal powder systems with a reactive organic medium. This type of ink material is converted to solderable pure metal during a low temperature cure without any organic binders or alloying elements.

A ferromagnetic conductive loaded resin-based material may be formed of the present invention to create a magnetic or magnetizable form of the material. Ferromagnetic micron conductive fibers and/or ferromagnetic conductive powders are mixed with the base resin. Ferrite materials and/or rare earth magnetic materials are added as a conductive loading to the base resin. With the substantially homogeneous mixing of the ferromagnetic micron conductive fibers and/or micron conductive powders, the ferromagnetic conductive loaded resin-based material is able to produce an excellent low cost, low weight magnetize-able item. The magnets and magnetic devices of the present invention can be magnetized during or after the molding process. The magnetic strength of the magnets and magnetic devices can be varied by adjusting the amount of ferromagnetic micron conductive fibers and/or ferromagnetic micron conductive powders that are incorporated with the base resin. By increasing the amount of the ferromagnetic doping, the strength of the magnet or magnetic devices is increased. The substantially homogenous mixing of the conductive fiber network allows for a substantial amount of fiber to be added to the base resin without causing the structural integrity of the item to decline. The ferromagnetic conductive loaded resin-based magnets display the excellent physical properties of the base resin, including flexibility, moldability, strength, and resistance to environmental corrosion, along with excellent magnetic ability. In addition, the unique ferromagnetic conductive loaded resin-based material facilitates formation of items that exhibit excellent thermal and electrical conductivity as well as magnetism.

A high aspect ratio magnet is easily achieved through the use of ferromagnetic conductive micron fiber or through the combination of ferromagnetic micron powder with conductive micron fiber. The use of micron conductive fiber allows for molding articles with a high aspect ratio of conductive fiber to cross sectional area. If a ferromagnetic micron fiber is used, then this high aspect ratio translates into a high quality magnetic article. Alternatively, if a ferromagnetic micron powder is combined with micron conductive fiber, then the magnetic effect of the powder is effectively spread throughout the molded article via the network of conductive fiber such that an effective high aspect ratio molded magnetic article is achieved. The ferromagnetic conductive loaded resin-based material may be magnetized, after molding, by exposing the molded article to a strong magnetic field. Alternatively, a strong magnetic field may be used to magnetize the ferromagnetic conductive loaded resin-based material during the molding process.

The ferromagnetic conductive loading is in the form of fiber, powder, or a combination of fiber and powder. The micron conductive powder may be metal fiber or metal plated fiber. If metal plated fiber is used, then the core fiber is a platable material and may be metal or non-metal. Exemplary ferromagnetic conductive fiber materials include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive fiber materials. Exemplary ferromagnetic micron powder leached onto the conductive fibers include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive powder materials. A ferromagnetic conductive loading may be combined with a non-ferromagnetic conductive loading to form a conductive loaded resin-based material that combines excellent conductive qualities with magnetic capabilities.

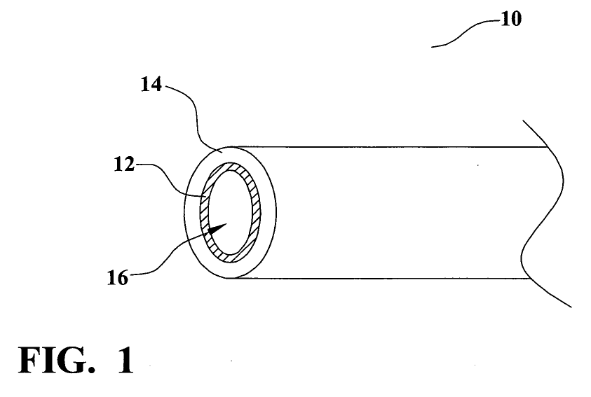

Referring now to FIG. 1, a first preferred embodiment of the present invention is illustrated. One of the preferred embodiments of the conductive loaded resin-based material in realizing a low cost fuel hose 10. Fuel hoses are used in vehicles to transport fuel from one location to another location. The exemplary fuel hose 10 is required to have many specific properties including gasoline resistance, gasohol resistance, fuel impermeability, and moisture impermeability. Further, the inner peripheral wall of the fuel hose is required to be electrically conductive in order to discharge static electricity. More specifically, the inner layer 12 is presently required to provide a conductivity of surface resistance (ASTM D 991) of 1010 ohms or less. The fuel hose 10 comprises an inner layer 12 and an outer layer 14. The inner layer 12 comprises conductive loaded resin-based material according to the present invention. This conductive loaded resin-based material provides the conductive path which safely discharges static electricity. One preferred embodiment of the fuel hose 10 comprises an inner layer 12 comprising conductive loaded resin-based material and an outer layer 14 comprising a non-conductive resin-based material such that an inner tubing 16 is formed. In this configuration, the outer layer 14 is used to provide properties which are desirable to the fuel hose 10 but which are difficult to achieve with the inner conductive layer 12. Such properties include, but are not limited to fuel impermeability and moisture impermeability. The material used to form the inner layer 12 differs from other materials found in the prior art in that the resins used and/or the doping powders and/or fibers used, and/or the size and proportion of doping powders and/or fibers used in the present invention are unique. The two layers 12 and 14 are formed by any of several means, including co-extrusion, or over-molding, or extruding consecutively. An additional embodiment of the present invention utilizes a single layer fuel hose. This is similar to the hose 10 shown in FIG. 1a except that the outer layer 14 is not included in this additional embodiment. Rather, the inner layer 12 is the only material used in this approach. The single layer comprises conductive loaded resin-based material of the present invention. This material provides the conductive path to safely discharge static electricity. The specific base resin and specific conductive doping particles are selected in order to provide the necessary properties for the fuel environment. Given the requirement of the fuel hose to discharge static electricity from the fuel, specific locations are selected within the vehicle to safely discharge the potential static electricity of the conductive loaded resin-based material fuel hose and these locations are connected to ground. The single layer hose is extremely economical to produce. It is preferably formed by extrusion. Referring again to FIG. 1a, a third embodiment of the fuel hose 10 of the present invention is shown in which the inner layer 12 comprises conductive loaded resin-based material and the outer layer 14 is a thin metal layer. The metal layer 14 is formed by plating or by coating or by other means. The metal outer layer 14 provides impermeability and chemical resistance as required for the application. The fuel hose 10 in each of the above-discussed embodiments is formed of a flexible resin if flexibility is desired for the application. Conversely, the fuel hose 100 is formed of a non-flexible resin if rigidity is preferred in the specific application.

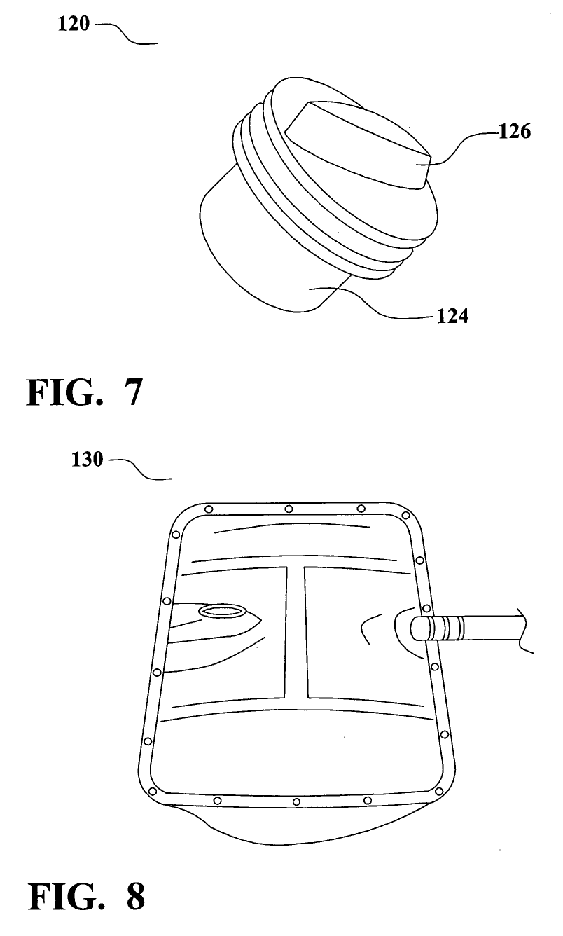

Referring now to FIG. 7, a second preferred embodiment of the present invention is illustrated. An exemplary fuel cap 120 is shown. A fuel cap is commonly used in vehicles to provide access to the fuel filler neck in order to add fuel to the fuel tank. The fuel cap is constructed so as to provide a secure seal to the fuel filler neck until such time as the vehicle operator purposely removes the cap to add fuel. The fuel cap commonly comprises several different components assembled into one unit. The components generally include those likely to contact fuel and/or fuel vapor on an almost continuous basis herein termed the inner components 124. Fuel cap components also include the outer components 126 which are less likely to experience continuous exposure to fuel and/or fuel vapor. The fuel cap 120 of the present invention comprises conductive loaded resin-based material for some or all of its components.

The base resin and conductive loaders for the inner components 124 are selected for high chemical resistance to fuel and fuel vapor among other properties. The base resin and conductive loaders for the outer components 126 are selected for strength, durability, and light weight characteristics, in addition to other desirable properties. The conductive loaded resin-based material of the present invention offers advantages over conventional plastic materials used in the prior art in that the conductive loaded resin-based material transmits electrical charge so that static electricity is discharged safely. Further, components comprising conductive loaded resin-based material of the present invention are economical to fabricate and very durable. In certain design applications, component wall thickness may be reduced in comparison to conventional plastic components, thus reducing material cost.

Referring now to FIG. 8, a third preferred embodiment of the present invention is illustrated. A low cost, highly effective fuel tank 130 is shown. The fuel tank 130 is a large reservoir used in vehicles to store fuel until it is needed by the engine. The conductive loaded resin-based material fuel tank 130 of the present invention offers significant advantages over the metal fuel tanks commonly found in the prior art. One advantage is cost. The conductive loaded resin-based material fuel tank 130 is molded using conventional molding techniques which provide a low cost fabrication process when compared to the metal forming process used for metal fuel tanks. A further advantage of the conductive loaded resin-based material fuel tank 130 is weight. A significant weight savings is realized by using the conductive loaded resin-based material. This weight savings brings about lower overall vehicle weight which in turn provides increased fuel economy. This increased fuel economy is important for meeting governmental regulations as well as providing customer satisfaction.

In the first embodiment of the conductive loaded resin-based material fuel tank 130, as described above, the entire fuel tank comprises conductive loaded resin-based material. This material provides the electrical conductivity needed for static electricity discharge. With the proper base resin and conductive loader selection, the conductive loaded resin-based material fuel tank 130 also provides the necessary chemical resistance, impermeability, and strength needed for this application. Still referring to FIG. 8, as an alternate embodiment the conductive loaded resin-based material is coated or plated with metal. The metal outer layer, not shown, is used to provide such features as additional impermeability, durability to stone impingement, visual characteristics, or other desirable properties. Yet another embodiment of FIG. 8 comprises multiple layers of resin-based materials, not shown, with at least one of these layers comprising conductive loaded resin-based material of the present invention. Each of the above embodiments provide the design flexibility and ease of manufacturing realized with conductive loaded resin-based material.

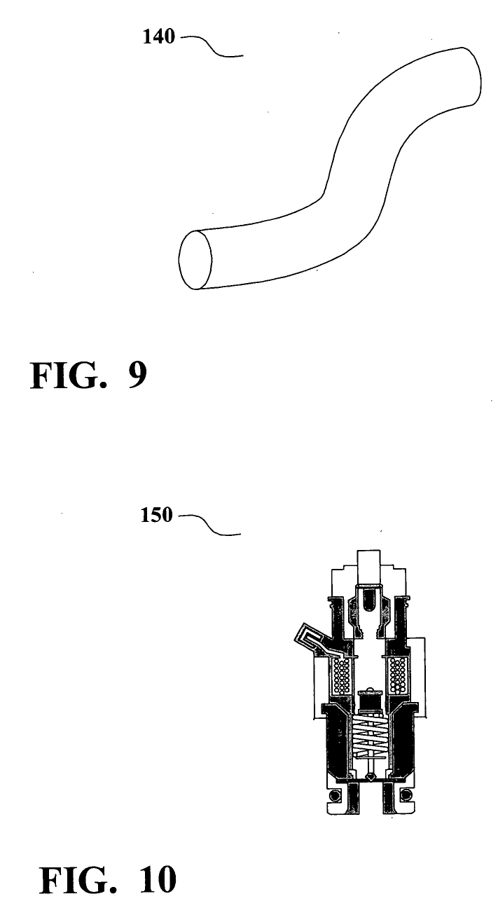

Referring now to FIG. 9, a fourth preferred embodiment of the present invention is illustrated. A fuel filler neck 140 is shown. The fuel filler neck is a tubular device used to transport fuel from the outside world into the fuel tank. That is, when the vehicle operator is replenishing the vehicle fuel supply, fuel travels through the fuel filler neck 140 to the fuel tank. Certain vehicle designs also include an additional fuel filler tube, not shown, between the fuel filler neck 140 and the fuel tank. The fuel filler neck 140 of the present invention comprises conductive loaded resin-based material. The conductive loaded resin-based material fuel filler neck 140 is preferably formed by extrusion, or injection molding, or may also be formed by other molding techniques. The conductive loaded resin-based material fuel filler neck 140 offers the advantage of low cost fabrication in addition to weight savings. The novel fuel filler neck 140 provides safe static electricity discharge and provides the necessary chemical properties required for contact with fuel. As an additional embodiment, the fuel filler neck 140 is plated or otherwise coated with metal. This metal layer(s), not shown, is used to provide additional features when desired. The fuel filler tube, not shown, is an additional preferred embodiment for conductive loaded resin-based material of the present invention. The fuel filler tube, not shown, is simply a tube used in certain vehicles to transport fuel from the fuel filler neck 140 to the fuel tank. The fuel filler tube, not shown, of the present invention comprises conductive loaded resin-based material. The conductive loaded resin-based material is used to form the only layer of the fuel filler tube, not shown. Or, as an alternate design, the conductive loaded resin-based material is plated or otherwise coated with metal. Fittings or connections, not shown, between fuel related components such as the fuel filler neck 140 of FIG. 1d or the fuel filler tube, not shown, and the fuel tank 130 of FIG. 1c are conductive loaded resin-based material or metal or a combination thereof. Likewise, other fuel line connectors comprise conductive loaded resin-based material as a part of the present invention. Alternately, connections are press fit or over-molded to join different fuel related components.

Referring now to FIG. 10, a fifth preferred embodiment of the present invention is illustrated. An exemplary fuel injector 150 is shown. Fuel injectors are used in modern vehicles, particularly automobiles, to provide a fine mist of fuel to the combustion chamber on an electronically controlled timing basis. The exemplary fuel injector 150 of the present invention utilizes components comprising conductive loaded resin-based material. Components typically fabricated of metal, ceramic, or plastic are hereby replaced with conductive loaded resin-based material for fuel injector applications.

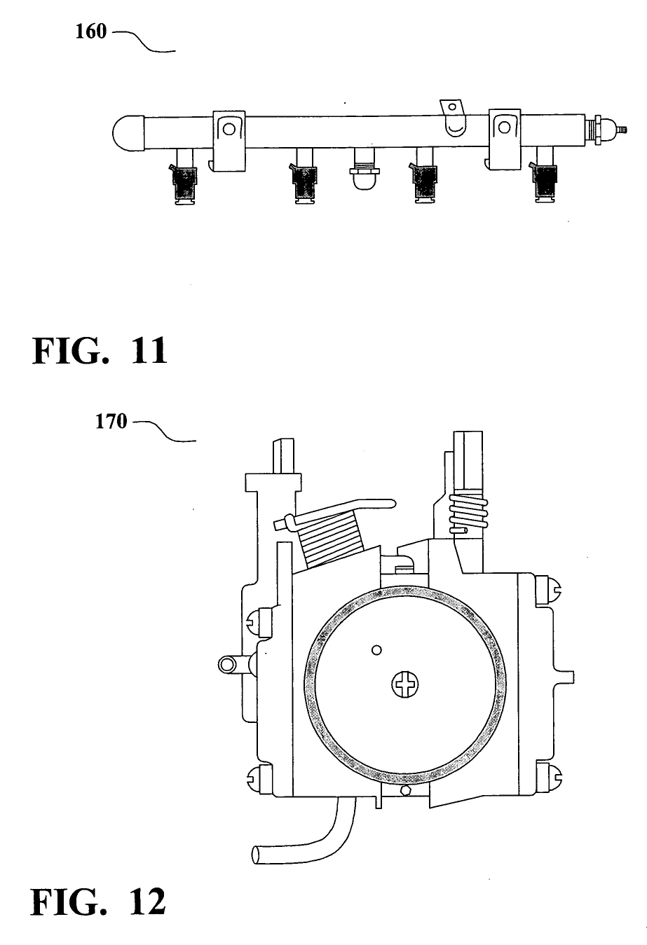

Referring now to FIG. 11, a sixth preferred embodiment of the present invention is shown. A fuel rail 160 comprising conductive loaded resin-based material is shown. The fuel rail 160 of the present invention is preferably formed by injection molding or another suitable technique. As an alternate embodiment, certain components, fittings, and/or interfaces are constructed of other materials such as metal. Conductive loaded resin-based material is over-molded to house these alternate materials or the alternate materials are otherwise inserted in the conductive loaded resin-based material body of the fuel rail 160. This results in a low cost, light weight fuel rail 160 which is very simple to manufacture.

Referring now to FIG. 12, a seventh preferred embodiment of the present invention is illustrated. A carburetor 170 comprising conductive loaded resin-based material is shown. Carburetors are used in older automobiles and other vehicles such as tractors to route fuel to the engine. Conductive loaded resin-based material offers many advantages to the carburetor. These advantages include, but are not limited to low cost fabrication and weight savings.

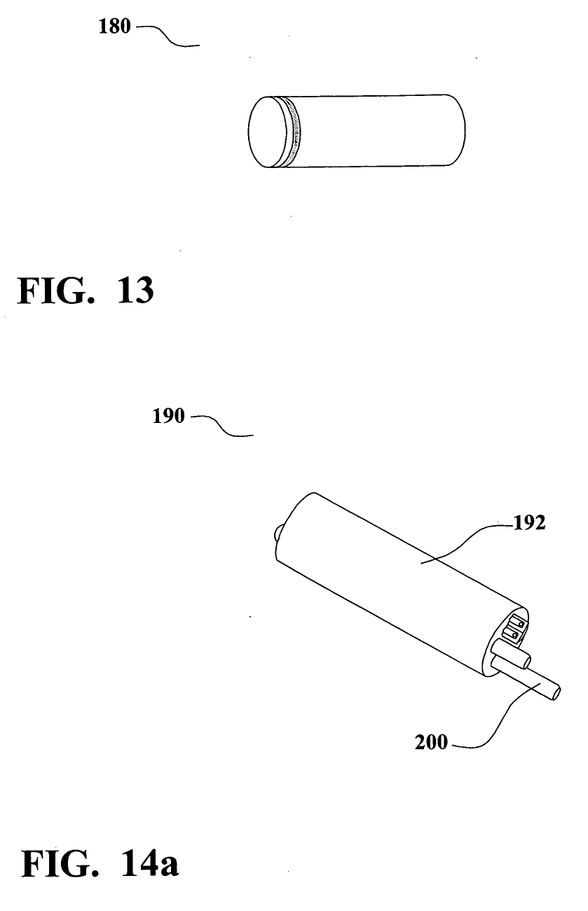

Referring now to FIG. 13, an eighth preferred embodiment of the present invention is illustrated. An exemplary fuel filter housing 180 comprising conductive loaded resin-based material is shown. The fuel filter is used in vehicle fuel systems to remove undesirable particles from the fuel. The conductive loaded resin-based material fuel filter housing 180 provides a low cost, highly effective product for use in vehicle fuel systems.

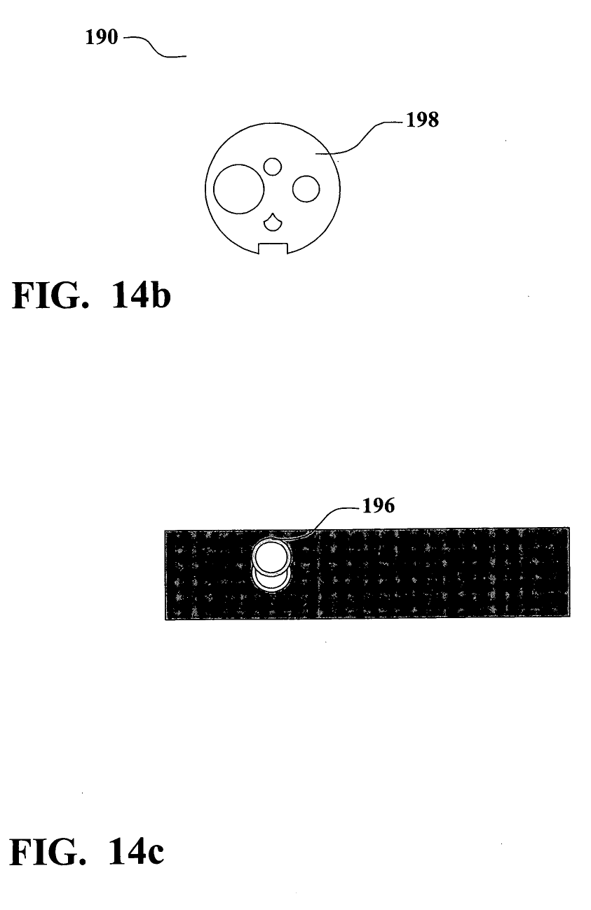

Referring now to FIGS. 14a-14c, a ninth preferred embodiment of the present invention is illustrated. An exemplary fuel pump 190 comprising conductive loaded resin-based material is shown. In modern vehicles, the fuel pump is typically packaged inside the fuel tank. The fuel pump 190 is used to pump fuel from the fuel tank to the other components of the fuel system. Conductive loaded resin-based material of the present invention is used to form any or all of the components of the fuel pump 190. The conductive loaded resin-based material components include, but are not limited to, the canister 192, the bag 194, the cap 196, the disk 198, the stem 200 and other interior components. The main body of the bag 194 is formed using flexible conductive loaded resin-based material so that the bag remains flexible during use. The portion of the bag 194 which interfaces with the cap 196 is more rigid to permit attachment of the cap 196. Again, conductive loaded resin-based material provides advantageous cost, weight, static electricity discharge and other performance characteristics for this and other vehicle fuel system components.

Several vehicle fuel system components have been described in detail above. Other such conductive loaded resin-based material components foreseen by this invention include, but are not limited to, the check valve, tube bundle clips, and fuel line connectors.

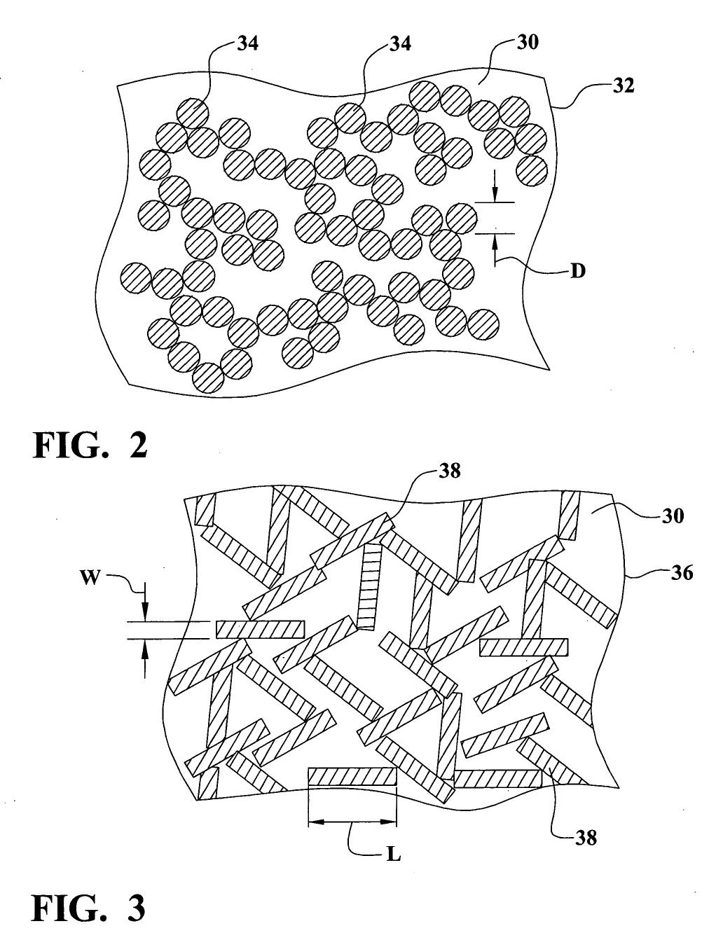

The conductive loaded resin-based material of the present invention typically comprises a micron powder(s) of conductor particles and/or in combination of micron fiber(s) substantially homogenized within a base resin host. FIG. 2 shows cross section view of an example of conductor loaded resin-based material 32 having powder of conductor particles 34 in a base resin host 30. In this example the diameter D of the conductor particles 34 in the powder is between about 3 and 12 microns.

FIG. 3 shows a cross section view of an example of conductor loaded resin-based material 36 having conductor fibers 38 in a base resin host 30. The conductor fibers 38 have a diameter of between about 3 and 12 microns, typically in the range of 10 microns or between about 8 and 12 microns, and a length of between about 2 and 14 millimeters. The micron conductive fibers 38 may be metal fiber or metal plated fiber. Further, the metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, or the like, or combinations thereof. Exemplary metal plating materials include, but are not limited to, copper, nickel, cobalt, silver, gold, palladium, platinum, ruthenium, and rhodium, and alloys of thereof. Any platable fiber may be used as the core for a non-metal fiber. Exemplary non-metal fibers include, but are not limited to, carbon, graphite, polyester, basalt, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fibers in the present invention.

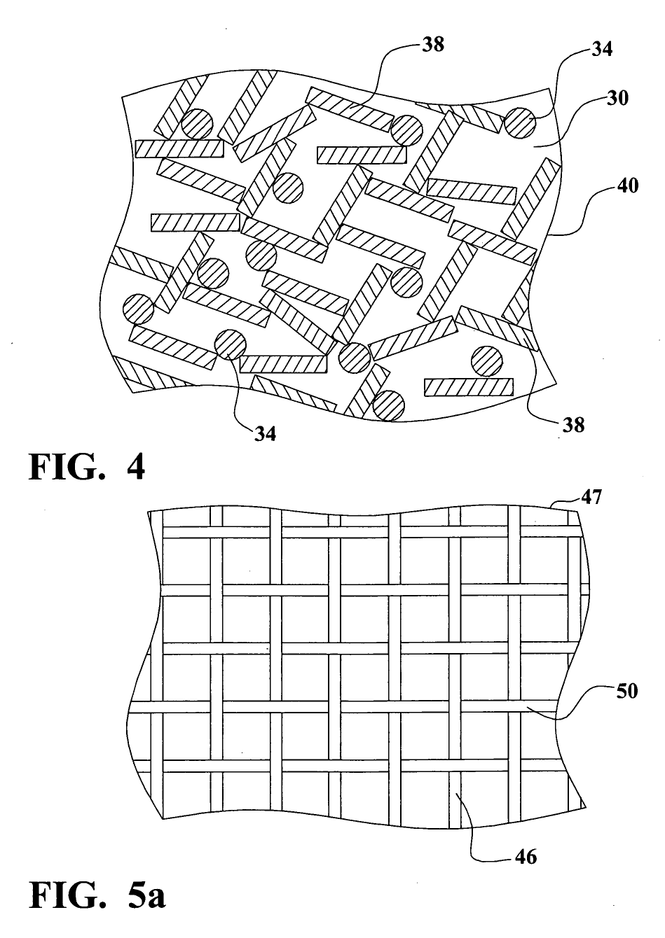

These conductor particles and/or fibers are substantially homogenized within a base resin. As previously mentioned, the conductive loaded resin-based materials have a sheet resistance between about 5 and 25 ohms per square, though other values can be achieved by varying the doping parameters and/or resin selection. To realize this sheet resistance the weight of the conductor material comprises between about 20% and about 50% of the total weight of the conductive loaded resin-based material. More preferably, the weight of the conductive material comprises between about 20% and about 40% of the total weight of the conductive loaded resin-based material. More preferably yet, the weight of the conductive material comprises between about 25% and about 35% of the total weight of the conductive loaded resin-based material. Still more preferably yet, the weight of the conductive material comprises about 30% of the total weight of the conductive loaded resin-based material. Stainless Steel Fiber of 6-12 micron in diameter and lengths of 4-6 mm and comprising, by weight, about 30% of the total weight of the conductive loaded resin-based material will produce a very highly conductive parameter, efficient within any EMF, thermal, acoustic, or electronic spectrum. Referring now to FIG. 4, another preferred embodiment of the present invention is illustrated where the conductive materials comprise a combination of both conductive powders 34 and micron conductive fibers 38 substantially homogenized together within the resin base 30 during a molding process.

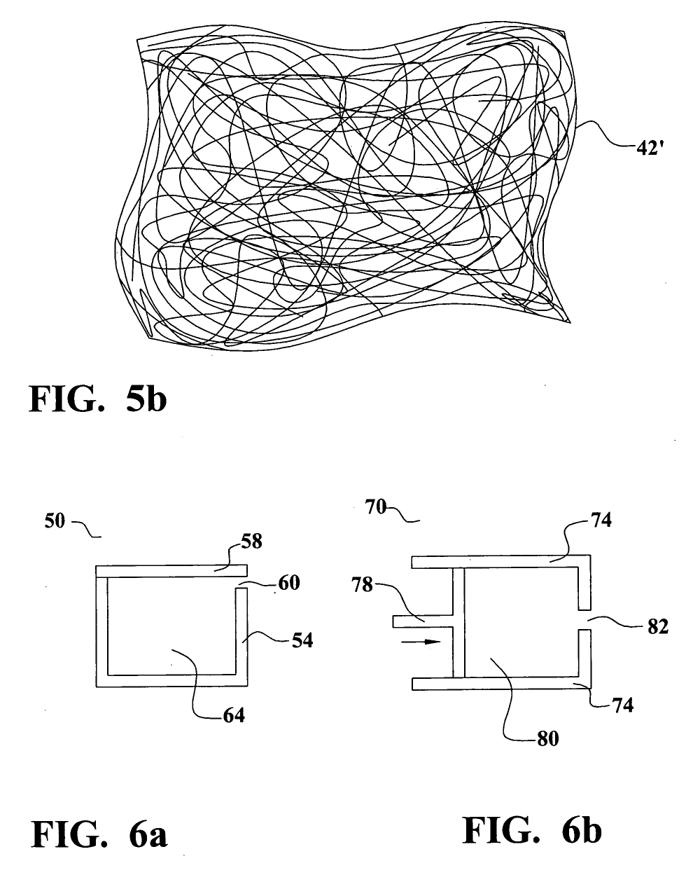

Referring now to FIGS. 5a and 5b, a preferred composition of the conductive loaded, resin-based material is illustrated. The conductive loaded resin-based material can be formed into fibers or textiles that are then woven or webbed into a conductive fabric. The conductive loaded resin-based material is formed in strands that can be woven as shown. FIG. 5a shows a conductive fabric 42 where the fibers are woven together in a two-dimensional weave 46 and 50 of fibers or textiles. FIG. 5b shows a conductive fabric 42′ where the fibers are formed in a webbed arrangement. In the webbed arrangement, one or more continuous strands of the conductive fiber are nested in a random fashion. The resulting conductive fabrics or textiles 42, see FIG. 5a, and 42′, see FIG. 5b, can be made very thin, thick, rigid, flexible or in solid form(s).

Similarly, a conductive, but cloth-like, material can be formed using woven or webbed micron stainless steel fibers, or other micron conductive fibers. These woven or webbed conductive cloths could also be sandwich laminated to one or more layers of materials such as Polyester(s), Teflon(s), Kevlar(s) or any other desired resin-based material(s). This conductive fabric may then be cut into desired shapes and sizes.

Vehicle fuel system components formed from conductive loaded resin-based materials can be formed or molded in a number of different ways including injection molding, extrusion, calendaring, or chemically induced molding or forming. FIG. 6a shows a simplified schematic diagram of an injection mold showing a lower portion 54 and upper portion 58 of the mold 50. Conductive loaded blended resin-based material is injected into the mold cavity 64 through an injection opening 60 and then the substantially homogenized conductive material cures by thermal reaction. The upper portion 58 and lower portion 54 of the mold are then separated or parted and the vehicle fuel system components are removed.

FIG. 6b shows a simplified schematic diagram of an extruder 70 for forming vehicle fuel system components using extrusion. Conductive loaded resin-based material(s) is placed in the hopper 80 of the extrusion unit 74. A piston, screw, press or other means 78 is then used to force the thermally molten or a chemically induced curing conductive loaded resin-based material through an extrusion opening 82 which shapes the thermally molten curing or chemically induced cured conductive loaded resin-based material to the desired shape. The conductive loaded resin-based material is then fully cured by chemical reaction or thermal reaction to a hardened or pliable state and is ready for use. Thermoplastic or thermosetting resin-based materials and associated processes may be used in molding the conductive loaded resin-based articles of the present invention.

The advantages of the present invention may now be summarized. An effective vehicle fuel system component is achieved. A method to form a vehicle fuel system component is achieved. The vehicle fuel system component is molded of conductive loaded resin-based materials. The vehicle fuel system component has reduced weight. The vehicle fuel system component displays excellent conductivity and electrostatic charge dissipation capability. The vehicle fuel system component is fuel impermeable. The electrical or thermal characteristics of the component can be altered or the visual characteristics can be altered by forming a metal layer over the conductive loaded resin-based material. The fuel system component is molded from a conductive loaded resin-based material incorporating various forms of the material. A method to fabricate a vehicle fuel system component from a conductive loaded resin-based material where the material is in the form of a fabric is achieved.

As shown in the preferred embodiments, the novel methods and devices of the present invention provide an effective and manufacturable alternative to the prior art.

While the invention has been particularly shown and described with reference to the preferred embodiments thereof, it will be understood by those skilled in the art that various changes in form and details may be made without departing from the spirit and scope of the invention.

What is claimed is:

1. A method to form a vehicle fuel delivery device, said method comprising:
providing a conductive loaded, resin-based material comprising conductive materials in a resin-based host; and
molding said conductive loaded, resin-based material into a vehicle fuel delivery device comprising a hollow fuel holding or transporting structure.

2. The method according to claim 1 wherein the percent by weight of said conductive materials is between about 20% and about 50% of the total weight of said conductive loaded resin-based material.

3. The method according to claim 1 wherein said conductive materials comprise micron conductive fiber.

4. The method according to claim 2 wherein said conductive materials further comprise conductive powder.

5. The method according to claim 1 wherein said conductive materials are metal.

6. The method according to claim 1 wherein said conductive materials are non-conductive materials with metal plating.

7. The method according to claim 1 wherein said step of molding comprises:
injecting said conductive loaded, resin-based material into a mold;
curing said conductive loaded, resin-based material; and
removing said vehicle fuel delivery device from said mold.

8. The method according to claim 1 wherein said step of molding comprises:
loading said conductive loaded, resin-based material into a chamber;
extruding said conductive loaded, resin-based material out of said chamber through a shaping outlet; and
curing said conductive loaded, resin-based material to form said vehicle fuel delivery device.

9. A method to form a vehicle fuel delivery device, said method comprising:
providing a conductive loaded, resin-based material comprising conductive materials in a resin-based host wherein the percent by weight of said conductive materials is between 20% and 40% of the total weight of said conductive loaded resin-based material; and
molding said conductive loaded, resin-based material into a vehicle fuel delivery device comprising a hollow fuel holding or transporting structure.

10. The method according to claim 9 wherein said conductive materials are nickel plated carbon micron fiber, stainless steel micron fiber, copper micron fiber, silver micron fiber or combinations thereof.

11. The method according to claim 9 wherein said conductive materials comprise micron conductive fiber and conductive powder.

12. The method according to claim 11 wherein said conductive powder is nickel, copper, or silver.

13. The method according to claim 11 wherein said conductive powder is a non-metallic material with a metal plating.

14. The method according to claim 9 wherein said hollow structure is a pipe or hose.

15. The method according to claim 9 wherein said hollow structure is a fuel tank.

16. The method according to claim 15 further comprising a filler neck comprising said conductive loaded resin-based material.

17. The method according to claim 16 further comprising a cap for said filler neck wherein said cap comprises said conductive loaded resin-based material.

18. The method according to claim 9 wherein said conductive loaded resin-based material further comprises a ferromagnetic material.

19. A method to form a vehicle fuel delivery device, said method comprising:
providing a conductive loaded, resin-based material comprising micron conductive fiber in a resin-based host wherein the percent by weight of said micron conductive fiber is between 20% and 50% of the total weight of said conductive loaded resin-based material; and
molding said conductive loaded, resin-based material into a vehicle fuel delivery device comprising a hollow fuel holding or transporting structure.

20. The method according to claim 20 wherein said micron conductive fiber is stainless steel.

21. The method according to claim 20 wherein said micron conductive fiber has a diameter of between about 3 μm and about 12 μm and a length of between about 2 mm and about 14 mm.

22. The method according to claim 20 wherein said device is a fuel filter.

23. The method according to claim 20 wherein said device comprises a fuel pump.

24. The method according to claim 20 wherein said conductive loaded resin-based material further comprises a ferromagnetic material.

25. The method according to claim 20 further comprising plating said conductive loaded resin-based material with a metal plating.
